(19) United States
(12) Patent Application Publication
(10) Pub. No.: US 2025/0335334 A1
(43) Pub. Date: Oct. 30, 2025

(54) SYSTEM AND METHOD FOR REPAIRING COMPUTER PROGRAMS AUTOMATICALLY WITHOUT EXECUTION

(71) Applicants: Constructor Technology AG, Schaffhausen (CH); Constructor Education and Research Genossenschaft, Schaffhausen (CH)

(72) Inventors: Huang Li, Shenzhen (CN); Bertrand Meyer, Zurich (CH); Ilgiz Mustafin, Neuhausen am Rheinfall (CH); Manuel Oriol, Zurich (CH)

(21) Appl. No.: 18/648,802

(22) Filed: Apr. 29, 2024

(51) Int. Cl. G06F 11/36

(52) U.S. Cl. CPC G06F 11/3636

(57) ABSTRACT

Systems and methods for automatically finding and fixing faults in software programs. The methodology is implemented by a tool that works solely on the basis of program text, using a prover. The tool verifies program code with a prover and if a fault is found, a set of counterexamples are generated that illustrate the causes of the proof failure. The tool uses the counterexample to infer invariants that characterize the circumstances under which the failure occurs. These invariants are used to generate candidate fixes, which are then validated by the prover. Correct fixes are applied to the program.

### TECHNICAL FIELD

The present disclosure generally relates to fault correction in software programs. More particularly, the disclosure describes systems, methods, and devices for static program repair.

### BACKGROUND

Dynamic program repair (DPR) is a class of automated program repair (APR) techniques that automatically fix faults in software programs. DPR tools typically work by first running the program with a set of test cases, and then using the results of the test runs to identify the locations of the faults. Once the faults have been identified, the DPR tool attempts to fix the faults by modifying the program. In contrast with DPR tools, static program repair (SPR) tools for APR do not need to run the program for fault identification and fix validation. SPR tools typically rely on formal methods, such as model checking or theorem proving, to analyze the program and identify potential faults.

AutoFix is a DPR tool that automatically generates repairs for programs based on a set of predefined patterns. AutoFix locates faults using dynamic program analysis (which is more time consuming) instead of proofs, and it proposes fixes based on simple heuristics and verifies them using a test suite (instead of proving the resulting code). Another tool based on similar concepts is JAID, which first extracts contracts, then applies fixing and validation techniques similar to those of AutoFix. Other tools, such as SemFix or Nopol, also use test suites as a tool for validating fixes generated through symbolic execution, which are prone to overfitting.

FootPatch, Maple, and Cccheck use formal approaches to identify faults, then create fixes and verify them. These three tools address and fix specific classes of faults. FootPatch addresses memory errors. Maple focuses on generating repairs in the form of linear arithmetic expressions. Cccheck addresses faults in contracts, initialization, method purity, and guards. Therefore, a more flexible solution for program repair generation, which has the potential to fix a wider range of faults as well as the ability to verify fixes for those faults, is needed.

### SUMMARY

A tool-based methodology is disclosed for generating program repairs without executing the program. The method includes the operations of running a prover on the program. If the prover fails to verify the program, it produces a counterexample that illustrates the reasons for the failure. A counterexample comprises a set of input values that leads to a proof failure. The method further includes generating counterexample invariants, which comprise predicates that hold in all counterexamples and generating a set of candidate fixes. The method also includes verifying, by the prover, that applying the set of candidate fixes to the program can eliminate the proof failure and does not introduce any new failure. The method allows programmers to select a fix from a list of candidate fixes that pass the verification. The part of the program that causes the original proof failure is replaced with the selected candidate fix.

In alternative embodiments, when a candidate fix is a contract fix for a routine r, and the operation of validating candidate fixes further comprises injecting a fault into r by inserting a contradictory assertion, the operation of generating candidate fixes for implementation comprises selecting a fix schema that abstracts common instruction patterns and instantiating the fix schema; the instantiated fix can replace the faulty code at the failure's location. Operations of fault identification and fix validation use static program verification and thus no test cases are needed. In an embodiment, the operation of replacing the portion of the program code that causes the proof failure takes place automatically when a candidate fix is selected by a programmer. The candidate fix can also be selected automatically. The method targets a generative scope of faults to be fixed and is not limited to a particular type of faults.

A system for identifying and fixing errors in programs using a processor and a storage medium is also disclosed. The system includes a tool comprising a prover, a constraint solver and an invariant inferencer. The prover is configured to detect potential faults in the program and to validate candidate fixes for the faults. The solver is configured to produce a set of counterexamples that illustrate the causes of the faults. The invariant inferencer is configured to produce counterexample invariants—predicates that hold in all counterexamples. The tool is also configured for generating a set of candidate fixes and filtering out the set of candidate fixes that eliminate the original proof failures and do not introduce new failures.

Alternatives similar to the method described above are also disclosed. For example, candidate fixes can comprise contract fixes that modify the specification of a routine r. In an embodiment, a contract includes assertions such as preconditions, postconditions, and invariants. In this case, the tool is further configured for injecting a fault into r by inserting a contradictory assertion. The candidate fixes may also comprise implementation fixes and the tool is further configured for selecting a fix schema among a set of common instruction patterns and for instantiating a fix schema. The instantiated fix schema may replace an instruction at the failure's location. The tool can be configured for error detection and for fix validation without using test cases. The tool can also be configured for replacing automatically a portion of the program code that causes the failure when a candidate fix is selected. The candidate fix may also be selected automatically. As with the methods of the preceding paragraphs, the detected errors are not limited to any particular type.

An alternative method is disclosed for selecting a fix for a fault in a program without executing the program. The operations are similar to method described above, but comprise an operation of filtering spurious fixes by injecting a fault into a plurality of candidate fixes. In this alternative method, candidate fixes that pass the proof but fail to detect the injected fault would be discarded. Similar alternatives are disclosed as in other embodiments. For example, the prover can be used for error detection and fix validation, and thus test cases are not needed. The operation of replacing a portion of the program code that causes the original proof failure can take place automatically when a fix is selected, either automatically or manually.

### BRIEF DESCRIPTION OF THE DRAWINGS

Exemplary embodiments are disclosed in the following figures.

FIG. 1 is an exemplary program to be checked for errors.

FIG. 2 is an exemplary report of proof failures for the program in FIG. 1.

FIG. 3 is an exemplary program code generated to fix errors in the program in FIG. 1.

FIG. 4 is an exemplary workflow of the disclosed method according to an embodiment.

FIG. 5 shows exemplary fix schemas used to generate the fixes shown in FIG. 3.

FIG. 6 is a table that shows exemplary fixing results according to an embodiment.

FIG. 7 is a table that shows exemplary correlation between failure causes and fixing results according to an embodiment.

The described embodiments are exemplary ways to use the invention to solve technical problems in the field of the invention. The solutions and techniques disclosed may also be used to solve other problems in the field or to solve similar problems in other fields. Substitutions, modifications, and equivalents known to those of skill in the art may be used to implement these solutions and techniques, consistent with the scope of the invention described in the claims.

### DETAILED DESCRIPTION

Systems and methods implement a method and tool for automatically finding and fixing errors in program code. The methodology is implemented by a tool that works solely on the basis of program text, using a prover. The tool works by first attempting to verify program code with a prover. If the prover finds a fault, it will generate a set of counterexamples that illustrate the causes of the failure. The tool then uses the counterexamples to infer invariants that characterize the circumstances under which the failure occurs. These invariants are used to generate candidate fixes, which are then verified by the prover. If the fix is correct, it will be applied to the program. In an embodiment, a system comprises at least one processor operably coupled to memory, and instructions that, when executed by the at least one processor, cause the at least one processor to implement the tool.

A “failure” of a software program refers to a case in which the execution of the program does not behave as expected, for example by producing an incorrect result, or not terminating, or terminating abnormally (for example by producing an arithmetic overflow or running out of memory), or allows prohibited behavior (for example by allowing unauthorized access from an attacker). A “fault” refers to an element in the software program that is not what the element should have been if the program had been produced properly. A “mistake” is a decision by a software developer that was not what it should have been. The causal chain of events is that a mistake produces a fault, which can lead to failures of the program's execution. A “correction” of a fault is a change to the software program that removes the fault. Alternate terms are also frequently used: “bug” is a more colloquial but commonly used synonym for “fault”; “error” is a commonly used synonym for “mistake”; “fix” and “repair” are commonly used synonyms for “correction”. In informal usage, “error” is sometimes used for “fault”. “Automatic Program Repair” (APR) consists of designing computer methods and tools for detecting faults and suggesting, and possibly applying, repairs.

Descriptions of object-oriented programming may include terms such as “class”, “object”, “attribute”, and “method.” In this context, the term “feature” covers both attributes and methods. As synonyms for “method”, the terms “routine” and “function” are also commonly used; a “procedure” is a method (routine) which does not return a result. The term “field” is also commonly used as a synonym for “attribute.” The term “member” is also commonly used as a synonym for “feature.”

A “program prover”, also known as a “program verifier”, or in context simply a “prover” or “verifier”, is a computer tool that can perform mathematical proofs of correctness of software programs. When a prover is used to attempt to prove a program correct, the proof or proof attempt either “succeeds” or “fails”. In the case the prover fails, one can state that a “proof failure” or “failure of the proof” has occurred. “Proof failure” is not to be confused with the failure of a program as defined above: a program failure is an incorrect execution of the program; a proof failure is the inability of a prover to prove a program correct.

Instead of validating fixes by running tests and making sure that they pass the tests, the fix validation uses proofs. A proof either provides a guarantee that the fix is correct with respect to the given specification, or determines that the fix is not valid. Fault localization is accomplished by an automated prover. The prover automatically identifies the program element that precludes verification, even down to the level of a particular instruction. Fix generation is accomplished by making changes at the location of the fault or before; reliance on an automatic prover helps avoid developer biases in debugging. These automatic verification processes can be repeated and run as often as needed without any additional cost to the system or in development time. Human code review is time consuming and subject to bias based on developer preferences and experience. Automated tools exhaustively cover every possible scenario, including scenarios that a human review cannot anticipate or imagine.

The methodology for using the tool to fix a fault can be summarized generally as follows. Computer software comprising program code is given to a prover. The prover attempts to verify the program code. If the prover finds a fault, it will automatically generate a counterexample that illustrates the failure. A set of counterexamples can be generated by running the verification iteratively with different seeds. The tool then uses the counterexamples to infer invariants that characterize the circumstances under which the failure occurs. The tool automatically generates candidate fixes based on the inferred invariants. The candidate fixes are verified by the prover. If the fix is correct, it will be applied to the program.

The errors found by the prover can be of different types. They include, for example, missing preconditions. These are conditions that must be true before a function or method is called.

If a precondition is not met, the function or method may produce incorrect results or crash. Incorrect implementation is another kind of error in program code that causes the program to behave incorrectly. For example, a function may not be calculating the correct value, or a loop may iterate forever. Too-restrictive precondition strengthening is another type of error that occurs when a precondition is too strict, making it difficult or impossible for the function or method to be called. Too-generous postcondition strengthening is a fault that occurs when a postcondition is too weak, allowing the function or method to produce incorrect results without being flagged as a fault. Yet another example of a fault is a spurious fix that recursively calls the routine itself to ensure its postcondition.

A counterexample is a set of specific values of variables that make a general statement false. A counterexample also comprises a specific input or set of inputs that causes a program to fail or produce an incorrect result. When the prover fails to verify a program, the prover produces one or more counterexamples that illustrate the cause of the failure. Each counterexample contains a sequence of states that document how the program reaches a failure state.

Counterexample invariants are obtained from the counterexamples. Invariants are derived from state invariants, which are predicates that hold at a specific state in a set of input program executions. The tool obtains state invariants by applying the invariant inferencer. These counterexample invariants characterize the circumstances under which a failure occurs and guide the process for generating candidate fixes. The tool uses counterexample invariants to synthesize candidate fixes. Invariants as described in this context are more general than the object-oriented concept of class invariant. Inferring counterexample invariants is described in detail below.

Verification of program code is handled by the prover. The prover establishes that every execution of a routine, if starting in a state satisfying the precondition and invariant, terminates in a state satisfying the postcondition and again the invariant. One such prover is AutoProof, which can be used by the tool in an exemplary embodiment. AutoProof can verify a class by leveraging the underlying SMT solver (such as the Z3 SMT solver) to produce a set of counterexamples illustrating failure. Each counterexample contains a trace (a sequence of states) documenting how the program reaches a failure state violating a contract. The tool uses these counterexamples to generate candidate fixes for the program. The candidate fixes are then verified using AutoProof again to retain only the fixes that both remove the original proof failure and introduce no extra failure. This process is repeated until all proof failures have been fixed.

Candidate fixes are potential solutions, generated by the tool, for correcting a software fault. The counterexample invariants, derived from the invariant inference tool (such as Daikon), identify the circumstances under which a failure occurs. These invariants characterize faulty inputs that lead to proof failure and are used to generate candidate fixes. Candidate fixes can be either contract fixes, which modify the specification of the routine, or implementation fixes, which modify the routine's implementation. The tool generates candidate fixes by instantiating fix schemas with proper instructions and counterexample invariants. The tool employs various techniques to ensure the validity of generated fixes, including injecting a contradictory assertion to filter out spurious fixes.

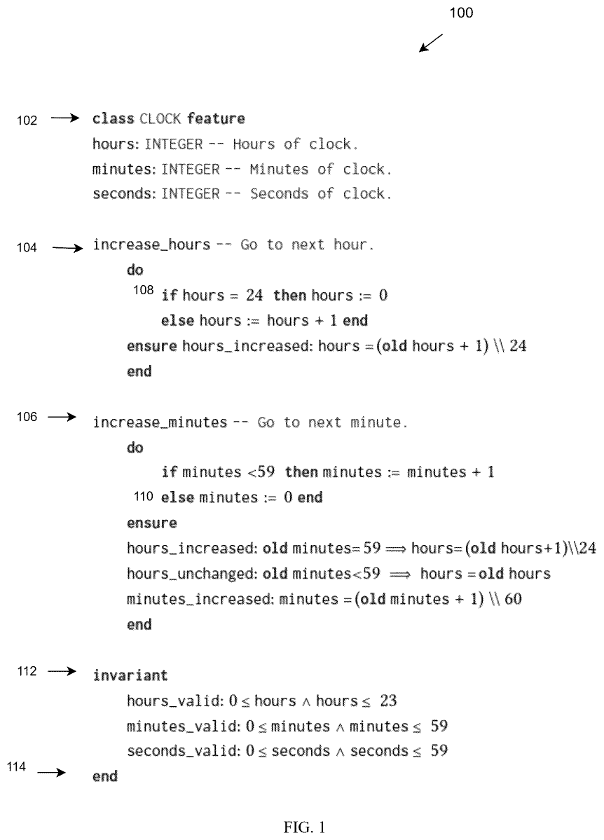

A typical embodiment showing how the tool is used will be described in connection with FIG. 1. The code example in FIG. 1 is an implementation of a digital clock in the Eiffel programming language. The clock has three properties: hours, minutes, and seconds, as shown in block 102. The clock has two methods, increase_hours 104 and increase_minutes 106, which increment the hours and minutes, respectively. The first failure is caused by the following fault: the incorrect comparison 108 in the hours=24 check. The correct comparison should be hours=23. The second failure is caused by the missing increment of the hours variable 110 in the increase_minutes block 106. Code block 112 refers to invariants. When adding to a class, in a language such as Eiffel or JML supporting class invariants, one or more invariant clauses can be added for that attribute in the invariant clause of the class. In FIG. 1, the invariant clause defines hours, minutes, and seconds. The end 114 of the code example follows invariant 112.

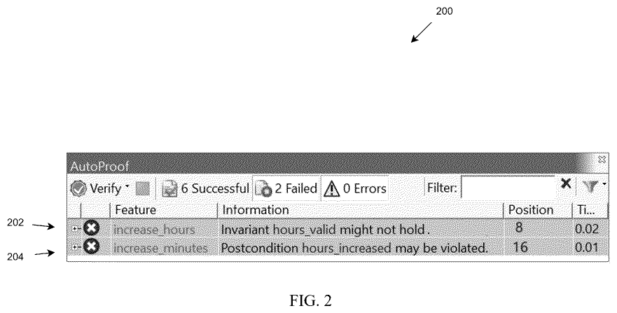

FIG. 2 shows the output 200 of the AutoProof tool when it is run on the code in FIG. 1. The tool found two faults in the code, each resulting from a mistake by the author of the code (developer). The first fault 202 is in the ‘increase_hours’ method. The condition ‘hours=24’ is incorrect. The correct condition should be ‘hours=23’. The second fault 204 is in the ‘increase_minutes’ method. The method does not increment the ‘hours’ variable when the ‘minutes’ variable is incremented to 59.

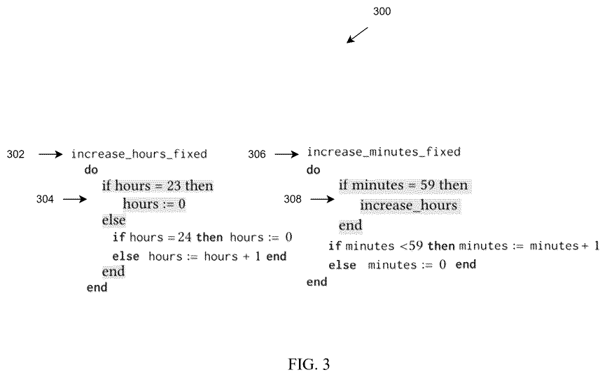

FIG. 3 shows the fixes generated for the faults found in FIG. 2. The fix 302 for the mistake in the ‘increase_hours’ method correctly sets the ‘hours’ variable to 0 when it is equal to 23 as shown by highlighted text 304. The fix for the mistake 306 in the ‘increase_minutes’ method calls the ‘increase_hours’ method when the ‘minutes’ variable is incremented to 59 as shown in highlighted text 308.

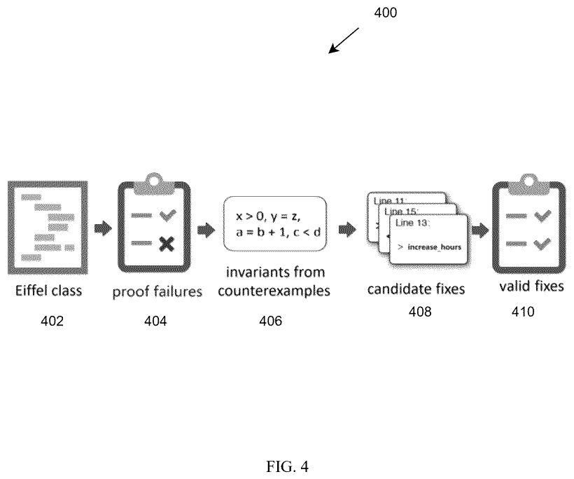

FIG. 4 summarizes an exemplary method 400 of generating fixes. Method 400 starts with the user providing a class to the tool at operation 402. The tool then attempts to verify the class with a theorem prover, such as AutoProof. If the proof is successful, the process terminates. However, if the proof fails at operation 404, the tool will generate a counterexample, which is a trace of a program execution leading to a program failure due to the underlying program fault. The counterexample is then used at operation 406 to infer invariants, which are predicates that hold in all counterexamples. These invariants characterize the circumstances under which a program failure occurs and guide the tool's process for generating candidate fixes at operation 408. The tool will then run the prover again to retain only the fixes that both remove the original proof failure and introduce no extra proof failure. Operation 410 generates possible valid fixes. Method 400 is implemented by inferring invariants from counterexamples and synthesizing candidate fixes based on the invariants.

In an exemplary embodiment, inferring counterexample invariants comprises the following operations. For a given class C and one of its routines r, let c₁, . . . , cₙ be the counterexamples produced by the prover when a failure of r occurs. Each cᵢ contains m states, which are represented by s₁^{ci}, . . . , sₘ^{ci}. Each state sⱼ^{ci} consists of a set of equalities between program expressions. This includes the attributes (fields) of C and the arguments of r—and their values in that state. To derive invariants that hold in all counterexamples, the counterexamples are passed into Daikon (an implementation of dynamic detection of likely invariants), which yields m sets inv₁, . . . , invₘ, where each invⱼ is a set of candidate invariants: predicates which hold in the j^{th} state in every counterexample. In formal terms, the counterexample invariants satisfy the condition:

$$∀ {c}_{i} ∈ \{ {c}_{1} , … , {c}_{n} \} , {{s}_{j}}^{ci} \vert = {inv}_{j}$$

This means that for every counterexample cᵢ and every state sⱼ^{ci} in that counterexample, the predicate invⱼ holds.

The derivation of counterexample invariants relies on a set of predefined templates. One of these templates comprises equality to primitive-type constants. For example, e=v where a boolean or integer expression e has the same value v in all counterexamples. Another template comprises a non-constant equality. For example, e1=e2 where e1 and e2 (not both constants) have the same value in every counterexample. A further template comprises linear relations. For example, properties of the form e1=a·e2+b or e1=a·“old” e2+b which hold in every counterexample, for integer expressions e1 and e2 and constants a and b.

The set P of invariants obtained from the templates comprises the basic invariants set. From this basic invariants set, a compound invariants set II is derived by combining pairs of basic invariants through conjunction and disjunction.

For example, if P={hours=23, minutes≥0}, then Π={hours=23, minute≥0, hours=23 V minutes≥0, hours=23 A minutes≥0}.

Deriving Π does not necessarily lead to a large number of selection because P is often a small set. Invariants in the initial state are used to characterize a set of faulty inputs that lead to the failure of proofs.

Counterexample variants, denoted as elements ϕ of the set II, are also referred to as failure conditions of a routine (method) r. Two kinds of candidate fixes can be produced. The first kind is a contract fix, which affects the specification of r (contract). The second kind is an implementation fix, which modifies the implementation (body).

Contract fixes may use the strategy of precondition strengthening, where “not ϕ” is added to r's precondition. This rules out faulty cases characterized by ϕ. Another kind of contract fix is postconditioning weakening; in this strategy, if ψ is the postcondition clause that causes the proof to fail, it is replaced by “not ϕ implies ψ”. With both strategies, the previously failing cases will now verify.

Precondition strengthening is useful because omission of a precondition clause is a common source of faults. An example of this type of fault is that the argument of a real-square-root routine must be non-negative. But precondition strengthening requires care in its application. Any routine will verify if prefaced by “require False.” Other cases are less obvious. For example, a proposed fix might add “not ϕ” and contradict existing clauses. For example, a supposed fix may add the precondition clause a>0 whereas r's precondition already includes a=0. Such an ineffective fix can be filtered out by inserting a contradictory assertion (for example, check False end) at the beginning of its body. Any candidate fix whose verification does not capture the injected fault is useless and hence will be discarded.

Implementation fixes are generated in steps. The first step comprises selecting a fix schema that abstracts common instruction patterns. The second step comprises instantiating the fix schema with proper instructions and ϕ.

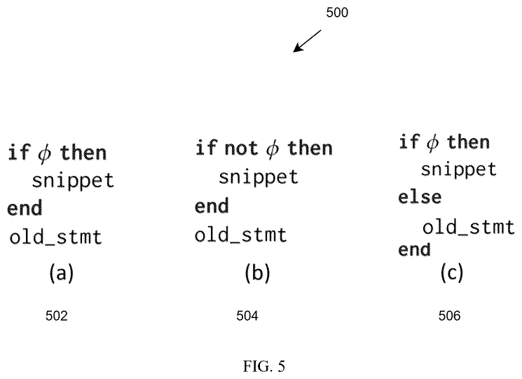

FIG. 5 shows examples 500 of implemented fix schemas. The “snippet” is a sequence of instructions, and “old_stmt” is some instructions, in the original program, related to the point of failure. It is assumed that the variables in the violated postcondition are suspicious. When instantiating “snippet,” instructions i are selected that alter their states, based on their types. One type is boolean, where i is an assignment e: =d, and d is the constant True or False or not e. Another type is integer, where i is an assignment e: =d where d is one of the constants 0, 1, and −1 or e+1 or e−1. Yet another type is reference, where i is a call to a command or procedure e.p (a₁, . . . , aₙ), where p is a routine available to the faulty routine and a₁, . . . , aₙ are the arguments. “old_stmt” is either the single instruction l at the failure's location, or the whole block that immediately contains l. Accordingly, the instantiated schema replaces the instruction at the failure's location or the whole block. In FIG. 5, schemas (a) 502, (b) 504, and (c) 506 are shown. Instantiating schemas 502 and 506 generate the two fixes 302 and 304 in FIG. 3.

When r contains multiple blocks, the tool identifies those involved in all counterexamples and gives them priority treatment because they are most likely to be faulty.

The effectiveness of generated fixes can be demonstrated by testing automatically-generated fixes on a collection of faulty programs, for example data-structure classes adapted from an old version of EiffelBase, examples in the AutoProof tutorials, and benchmarks of previous software verification competitions. The EiffelBase examples comprise faults that arose in earlier released versions of the library. and were not detected during testing, but were later reported by users of the library or found through other means. They hence have the benefit of containing actual faults, resulting from mistakes made by human developers, rather than artificial or so-called “seeded” or “injected” faults, as sometimes used in verification research to assess verification methods.

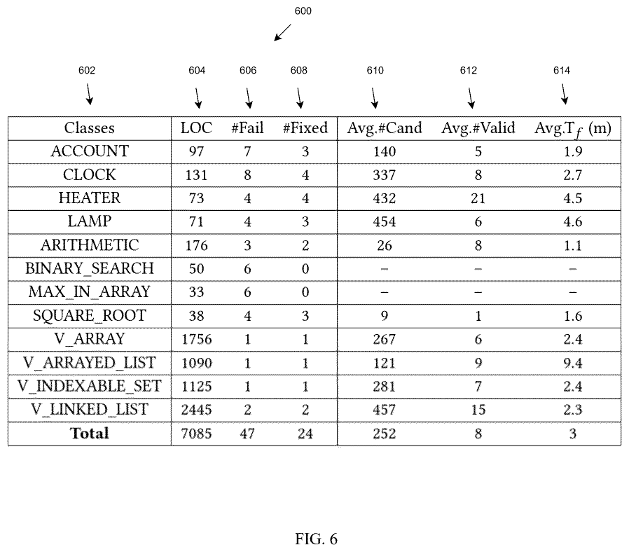

FIG. 6 is a table 600 that shows exemplary results of the tool on a collection of faulty programs. The table of FIG. 6 shows the information for each of classes 602. The first column 604 shows the number of lines of code in the class (LOC). The second column 606 shows the number of failures detected by AutoProof in the class (#Fail). The third column 608 shows the number of failures for which the tool was able to generate at least one valid fix (#Fixed). The fourth column 610 shows the average number of candidate fixes generated by the tool for each failure (Avg.#Cand). The fifth column 612 shows the average number of valid fixes generated by the tool for each failure (Avg.#Valid). The sixth column 614 shows the average time (in minutes) it took the tool to generate a fix for each failure (Avg.Tf(m)). As shown in FIG. 6, 24 of the 47 failures detected by AutoProof were fixed. For each of the 24 fixed failures, the tool generated 252 candidates and 8 valid fixes.

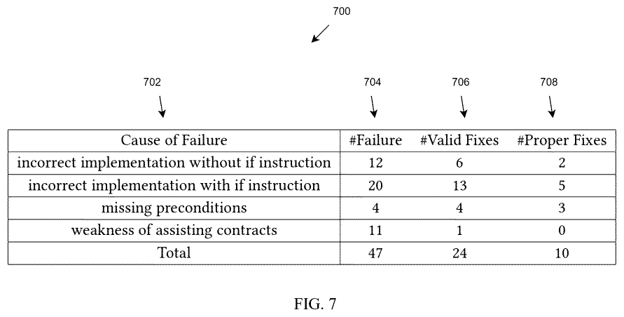

FIG. 7 is a table 700 that correlates the causes of proof failures 702, the number of failures 704, the number of valid fixes 706, and proper fixes 708 found by the tool for each cause. The causes of proof failures include incorrect implementations with and without “if” instructions, missing preconditions, and weakness of assisting contracts, which are contracts used for verification purposes, such as the postcondition of callee or a loop variant. The table shows that the tool was able to find valid fixes for 24 of the 47 failures detected by AutoProof. Of the 24 failures, 12 were caused by incorrect implementations without an if statement, 20 were caused by incorrect implementations with an if statement, 4 were caused by missing preconditions, and 1 was caused by weakness of assisting contracts. Overall, fixes were found for 6 of the 12 failures caused by incorrect implementations without an if statement, 13 of the 20 failures caused by incorrect implementations with an if statement, 4 of the 4 failures caused by missing preconditions, and 0 of the 1 failure caused by weakness of assisting contracts.

1. A computer-implemented method for fixing a fault in a software program without executing the program, the method comprising:
running a prover on the program code;
detecting, by the prover, faults in the program code;
producing counterexamples that illustrate the causes of the detected faults, wherein the counterexamples comprise input values that cause the faults;
generating counterexample invariants, wherein counterexample invariants comprise predicates that hold in all counterexamples;
generating a set of candidate fixes;
verifying, by the prover, that the set of candidate fixes pass the proof;
selecting a candidate fix from the set of candidate fixes that pass the proof; and
replacing a portion of the program code that causes the original proof failure with the selected candidate fix.

2. The method of claim 1, wherein the set of candidate fixes comprises contract fixes affecting the specification of r, and selecting the candidate fix further comprises injecting a fault into r by inserting a contradictory assertion.

3. The method of claim 1, wherein the set of candidate fixes comprises implementation fixes and generating the set of candidate fixes comprises selecting a fix schema that abstracts common instruction patterns and instantiating the fix schema.

4. The method of claim 3, wherein the instantiated fix schema replaces an instruction at a location of a fault.

5. The method of claim 1, wherein the prover is configured for mistake detection and fix validation and mistake detection and fix validation do not use test cases.

6. The method of claim 5, wherein the replacing the portion of the program code that causes the first mistake takes place automatically when a candidate fix is selected.

7. The method of claim 6, wherein the candidate fix is selected automatically by the fixing tool.

8. The method of claim 1, wherein the detected faults are not limited to any particular type.

9. A system for identifying and fixing a fault in program code, the system comprising:
at least one processor operably coupled to memory, and instructions that, when executed by the at least one processor, cause the at least one processor to implement:
a tool comprising a prover and a constraint solver and an invariant inferencer;
wherein the prover is configured to detect faults in the program code and to validate candidate fixes;
wherein the solver is configured to produce a set of counterexamples that illustrate the causes of the detected faults;
wherein the invariant inferencer is configured to produce counterexample invariants comprising predicates that hold in all counterexamples; and
wherein the tool is configured for generating a set of candidate fixes and verifying, using the prover, that the set of candidate fixes pass the proof.

10. The system of claim 9, wherein the set of candidate fixes comprise contract fixes affecting the specification of a routine r, and the tool is further configured for injecting a fault into r by inserting a contradictory assertion.

11. The system of claim 9, wherein the set of candidate fixes comprise implementation fixes and the tool is further configured for selecting a fix schema that abstracts common instruction patterns and for instantiating the fix schema.

12. The system of claim 11, wherein the instantiated fix schema replaces an instruction at a location of a fault.

13. The system of claim 11, wherein the tool is configured for mistake detection and for fix validation without using test cases.

14. The system of claim 13, wherein the tool is configured for replacing a portion of the program code that causes the proof failure automatically when a candidate fix is selected.

15. The system of claim 14, wherein the tool is configured to select the candidate fix automatically.

16. The system of claim 11, wherein the detected faults are not limited to any particular type.

17. A computer-implemented method for selecting a fix for an mistake in program code without executing the program code, the method comprising:
running a prover on the program code;
detecting, by the prover, faults in the program code;
producing a set of counterexamples that illustrate the causes of the detected faults;
wherein the counterexamples comprise input values that cause the faults;
generating counterexample invariants, wherein counterexample invariants comprise predicates that hold in all counterexamples;
generating a set of candidate fixes;
verifying, by the prover, that the set of candidate fixes pass the proof;
filtering spurious fixes by injecting a fault into a plurality of candidate fixes; and
selecting a candidate fix from the set of candidate fixes that pass the proof and discarding the candidate fixes with which the prover fails to detect the injected fault.

18. The method of claim 17, wherein the prover is used for mistake detection and fix validation and mistake detection and fix validation do not use test cases.

19. The method of claim 17, wherein the replacing a portion of the program code that causes the first mistake takes place automatically when a candidate fix is selected.

20. The method of claim 19, wherein the candidate fix is selected manually or automatically.
